(19) United States
(12) Patent Application Publication
(10) Pub. No.: US 2018/0068517 A1
(43) Pub. Date: Mar. 8, 2018

(54) ELECTRONIC CHIP TRAY WITH CHIP SENSORS

(71) Applicants: Charles Drennan, III, Brighton, CO (US); Adam Daines, Red Deer (CA); Todd Taylor, Golden, CO (US)

(72) Inventors: Charles Drennan, III, Brighton, CO (US); Adam Daines, Red Deer (CA); Todd Taylor, Golden, CO (US)

(21) Appl. No.: 15/269,976

(22) Filed: Sep. 19, 2016

Related U.S. Application Data
(60) Provisional application No. 62/384,157, filed on Sep. 6, 2016.
(60) Provisional application No. 62/394,750, filed on Sep. 14, 2016.

(51) Int. Cl. G07F 17/32; A63F 13/98; A63F 3/00; A63F 1/06

(52) U.S. Cl. CPC G07F 17/3202; A63F 13/98; A63F 1/06; A63F 1/067; G07F 17/322; A63F 3/00157

(57) ABSTRACT

A system and method to receive side wagers such as progressive wager. A plurality of sensors is located on or near the dealer's chip tray at a casino table, there is one such sensor for each player that the table can accommodate. Before a new game is dealt at the table, players place their main wagers and their side wagers. The dealer will then move all of the side wagers to their respective sensors of the plurality of sensors. The dealer will then deal the game from start to finish, and will use the side wagers placed on the plurality of sensors to determine which players have made the side wager. Only players who have made the side wager are eligible for a side wager payout.

### CROSS REFERENCE TO RELATED APPLICATIONS

This application claims benefit to U.S. provisional application 62/384,157, which is incorporated by reference herein in its entirety. This application also claims benefit to U.S. provisional application 62/394,750, which is incorporated by reference herein in its entirety.

### BACKGROUND OF THE INVENTION

### Field of the Invention

The present general inventive concept is directed to a method, apparatus, and computer readable storage medium directed to a casino chip tray with sensors for wagers.

### Description of the Related Art

Currently, casinos offer wagering games along with optional side or progressive bets. Players who choose to make the side wager (or progressive) can place their chip down a slot or place it on a progressive betting circle directly in front of each player (adjacent to a main wager betting circle). A sensor may light up on the progressive betting circle to indicate that the player has made the bet. After the game is over, the main wager is resolved as well as the side/progressive wager (if made).

Prior art progressive tables also can have holes cut in them below side wager slots for each player. Thus, players place their progressive wager (a chip) inside their respective slot and the dealer presses a button which drops the chip into the slot and identifies which player made the progressive wager (e.g., by lighting a light by each slot), etc. The dealer will know which player made the progressive wager based on which slots are lit up. Of course, only players who placed the progressive wager will be entitled to winnings if they quality for a progressive payout.

Disadvantages with the above methods is that they require specially equipped gaming tables.

### SUMMARY OF THE INVENTION

It is an aspect of the present invention to provide an improved wager placement system.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a drawing of a table layout, according to an embodiment;

FIG. 2 is a flowchart illustrating an exemplary method of resolving side wagers using a chip tray with sensors, according to an embodiment;

FIG. 3 is a block diagram illustrating hardware that can be used for the chip tray, according to an embodiment;

FIG. 4 is a block diagram illustrating the connections between the processor and the lights and sensors, according to an embodiment;

FIG. 5 is a drawing of a casino table with a chip tray and sensor bar, according to an embodiment;

FIG. 6 is a drawing of the chip tray attached to a drawer, according to an embodiment;

FIG. 7 is a drawing of an underside of the sensor bar, according to an embodiment;

FIG. 8 is a drawing of a pair of sensor bars inserted into a standard chip tray, according to an embodiment; and

FIG. 9 is a drawing of the pair of sensor bars inserted into the standard chip try with a hole card reader, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, system, and computer readable storage medium to accept side wagers placed on a casino gaming table. Throughout this document, side wagers are treated the same as progressive wagers (and also bonus wagers), and all of these types of wagers are handled the same way for the purposes of this invention. Thus, “side wager” refers to any additional wager that can be placed by the player in addition to a main wager.

A chip tray is standard equipment for a casino gaming table. The chip tray is typically made out of metal (although can also be made out of plastic, composite, or any suitable material) and has hollow tubes for the placement of casino chips (which are redeemable for cash at a casino cashier). The chip tray can also be made out of metal and have a composite material (e.g., plastic, etc.) as a coating applied over the metal.

According to an embodiment, a chip tray can comprise sensors to detect side wagers (this is in contrast to such sensors being embedded on the casino table). The chip tray can house the sensors and all of the electronics. As such, in order to equip a table to be able to accept and acknowledge side bets,

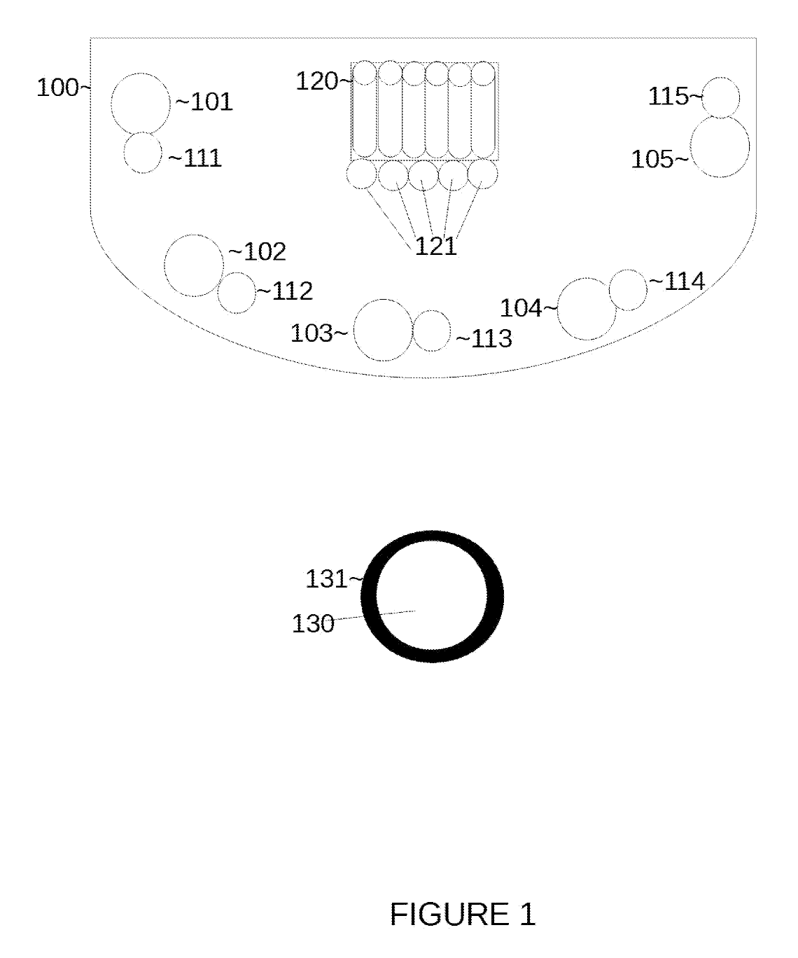

FIG. 1 is a drawing of a table layout, according to an embodiment. A physical table 100 has a felt on top with betting circles imprinted on the felt.

Each player has their own respective main wager betting circles and side wager betting circles. For example, player 1 has player 1 main wager betting circle 101 and player 1 side wager betting circle 111, player 2 has player 2 main wager betting circle 102 and player 2 side wager betting circle 112, etc. There are typically no sensors on the main wager betting circles 101, 102, 103, 104, 105 and the side wager betting circles 111, 112, 113, 114, 115. Note that the circles do not need to be “circles” and can be any shape (e.g., betting square, etc.). Furthermore, there does not need to be a shape at all marked on the felt and each player would be considered to have his/her own “betting area” which comprises a “main wager betting area” and a “side wager betting area.” These areas do not need to be physically marked on the felt.

The chip tray 120 is in the back of the table 100 towards the center. The five sensors 121 are located in front of the chip 120 although they can be located anywhere on the table typically within easy reach of the dealer. There is one sensor for each player at the table, in other words if there are five betting areas on the table (i.e. the table can accommodate five players) then there would be five such sensors (one dedicated for each of the five potential players).

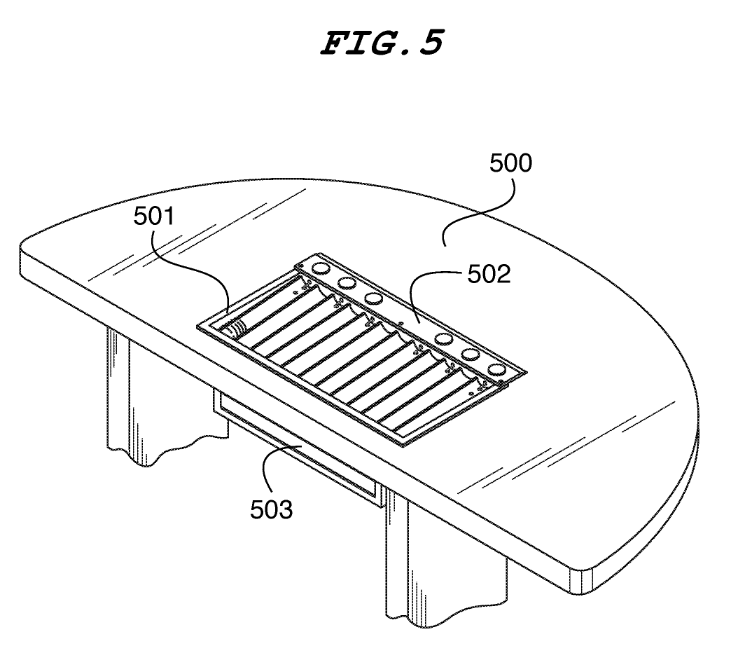

A sensor 130 is enlarged showing the light 131 surrounding the sensor 130. The light 131 lights up when a chip is placed on the sensor and unlights when no chip is present on the sensor. The light can come in any other configuration, for example the entire sensor 130 can be illuminated or only an area surrounding the sensor 130. The light is used to indicate which sensors have side wagers placed so that even if the side wagers are removed from the sensors (after the side wagers closed button 305 is pressed) the status is maintained so that the dealer can ascertain which players made the side wager for the current game. All of the sensors shown in the other figures (e.g., the six sensors shown in FIG. 5, etc.) can have this structure, that is a sensor that detects a chip being placed on it and a light (e.g., LED or other illuminating device) that can light up when triggered to do so (and turn off when triggered to turn off).

Note that the table 100 illustrated in FIG. 1 can accommodate five players although such tables can accommodate any number of players (e.g., 3-10 or more). There would be one set of betting areas for each player on the table. A set of betting areas comprises a main wager betting circle, a side wager betting circle, and a corresponding sensor/light.

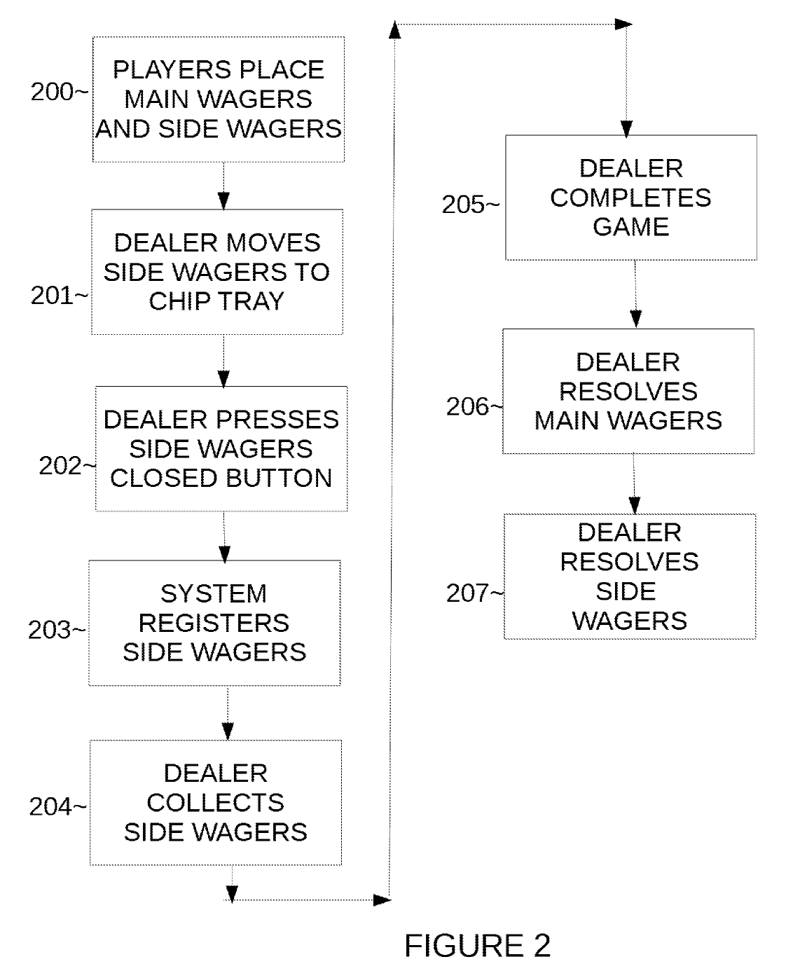

FIG. 2 is a flowchart illustrating an exemplary method of resolving side wagers using a chip tray with sensors, according to an embodiment.

The method can begin with operation 200, wherein players place main wagers and side wagers. Before a new game begins, players place their main wagers in their main wager betting circles and place their side wagers in their respective side wager betting circles. Wagers are placed in the form of physical chips which are redeemable by the players at a casino cashier for cash.

From operation 200, the method proceeds to operation 201, wherein after all players have placed their wagers, the dealer on the table moves each player's side wagers (also referred to as side bets) to respective sensors in the chip tray. There is a respective sensor in the chip tray for each player's side wager betting circle. For example, if player 1 on a table placed a side wager then the dealer would take that side wager and put it on the player 1 sensor on the chip tray, if player 2 on the table placed a side wager then the dealer would take that side wager and put in on the player 2 sensor on the chip tray, etc.

Each sensor on the chip tray will sense the presence (or alternatively the absence) of a chip (or chips). This will send a signal to the processor 300 so that the processor knows which sensors have at least one chip on them and which ones do not. The sensors can be any type of sensor, such as optical (e.g., it detects light so that a chip placed on top of the sensor would block all light), RFID (e.g., each chip has an RFID chip inside it which can be detected), weight (each sensor has a miniature scale which can detect small weights such as 0.5 ounce or other weight, etc.) A light 308 on (or near, or around) each sensor can light up once a chip has been placed to indicate that the side wager has been placed. If no side wager is placed (e.g., no chip is on the sensor) then the light would be off.

From operation 201, the method proceeds to operation 202, in which after the players have all placed their bets the dealer presses a side wagers closed button 305 (and can optionally announce “no more bets”). At this point the casino rules prohibit players who did not place a side wager from placing a side wager. All lights 308 that indicate side wagers have been placed are now locked, that is removing the chips on the sensors would not turn the respective lights off, and lights that are off will not turn on now. Thus, all lights 508 remain in their same state until the reset button 306 is pushed.

From operation 202, the method proceeds to operation 203, in which the system (directed by the processor 300) registers the side wagers. In other words, the side wagers closed button 202 instructs the processor 300 to record which sensors on the chip tray have a side wager and which do not and this data can be stored in memory (e.g., RAM 302, storage device 303, etc.) At this point removal of chips from the sensors on the chip tray will not affect the data as the statuses are now already recorded and locked in.

From operation 203, the method proceeds to operation 204, wherein the dealer can collect all of the side wagers on the sensors on the chip tray (and typically put them in a respective tube in the chip tray). For example, the chip tray would have different tubes for different denomination chips (e.g., $1 chips, $5 chips, $25 chips, etc.) and if the side wager placed is a $1 chip then the dealer would put these chips in the $1 chip tube. Thus, all of the chips on the sensors on the chip tray are now removed and collected by the dealer.

From operation 204, the method proceeds to operation 205, wherein the dealer completes the game. It does not matter that type of game is being played, e.g., blackjack, baccarat, etc. Completing the game means the dealer, according to rules of the game, deals all the cards according to a predetermined dealing procedure and providing all players their opportunity to make any game choice(s) they can make in the game.

From operation 205, the method proceeds to operation 206, wherein the dealer resolves the main wager. The main wager is typically a mandatory wager that is based on the outcome of the game (e.g., if the player wins the game the player receives a payout on the main wager). If the player wins the player receives a payout based on the main wager and if the player loses then the player loses the main wager which is collected by the house.

From operation 206, the method proceeds to operation 207, wherein the dealer resolves the side wagers. Of course, for players who did not make the side wager, there is nothing that needs to be done as these players are not eligible to receive any payout for any winning side wagers had they placed on. The dealer would be able to tell by which lights 308 are lit up which players placed the side wager. For players who placed the side wager, they are eligible to win a payout of conditions to win the side wager are present for that player (e.g., the player's hand is high ranking hand such as a royal flush, etc.)

At this point the dealer can press the reset button 306 which resets all of the states of the data of which sensors had side wagers. In other words, no chips would typically be present on the sensors and once the reset button 306 is pressed then all of the lights 308 would be turned off and the status for each sensor would be that no side wager has been placed (until of course a chip is then placed on a sensor).

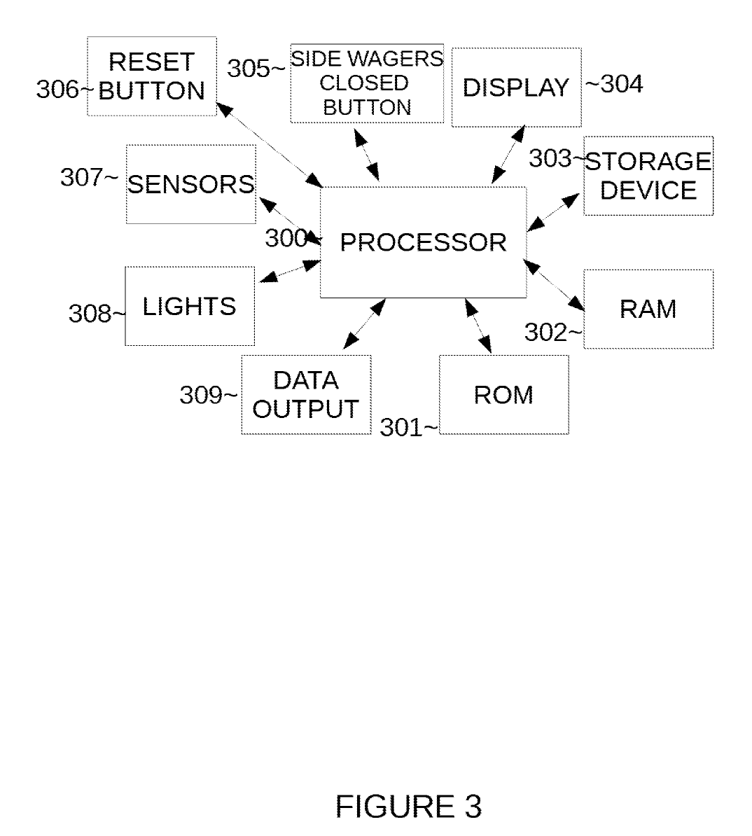

FIG. 3 is a block diagram illustrating hardware that can be used for the chip tray, according to an embodiment. Note that all of the electronics can be housed directly under the chip tray, such as in a drawer under the chip tray where it can be accessed for maintenance.

A processor 300 can be a microprocessor and any associated structure (e.g., bus, cache, power supply, etc.) The processor 300 can be connected to a ROM 301 (which can store data and/or instructions required for the system to operate, etc.), a RAM 302 (which can store temporary data such as which sensors have a side wager), a storage device 303 which (can be volatile and/or nonvolatile) and can store data such as which sensors have a side wager. The storage device 303 can be, for example, an EPROM, a hard drive (which reads/writes to a hard disc), a flash memory, etc. Any storage device can store computer readable instructions (a computer program) which are read and executed by the processor 300 which would cause the processor 300 to implement any and all of the features described herein.

In the embodiment of a progressive wager (in other words the side wager is a progressive wager for a progressive jackpot), there can be a display 304 which displays a current amount of the progressive meter. A progressive jackpot is a jackpot amount that continuously changes (typically increases until it is won) and a portion of each progressive wager placed goes to fund the progressive jackpot (and the remainder is kept by the house/casino). Thus, the processor 300 can be programmed to compute the current progressive amount (e.g., compute a percentage of the progressive wagers placed and increase the progressive jackpot amount by this amount). A display 304 can be a digital display in view of the table that displays the current progressive jackpot amount.

The processor 300 can also be connected to a plurality of sensors 307 and lights 308. As described herein, each of the plurality of sensors can sense (detect) the presence and absence of a chip placed on the sensor. Each sensor can be a photosensor (which can detect light) so that a chip would block the photosensor (thus resulting in the side wager being placed on this sensor and causing the respective light to light up). Alternatively, each sensor can also be a scale which can detect a small weight (e.g, one half ounce or other amount) and when the weight is detected then it would be triggered that a side wager is placed (if there is no weight then the side wager is not detected). Alternatively, each sensor can also be an RFID detector which can detect the presence (and absence) of an RFID chip inside a chip in very close proximity to the sensor which would determine whether the side wager has been placed or not. The circuitry is configured such that when a sensor 307 detects the present of a chip then that sensor's respective light 308 would automatically light up. This behavior would continue until the side wagers closed button 305 is pressed upon then the state (whether the side wager was placed or not for each sensor) is locked in (until the reset button 306 is pressed).

The processor 300 can also be connected to a side wagers closed button 305. The dealer can announce “last call for placing side wagers” and once all players have placed their side wagers (or decided not to player their side wagers) then the dealer would press the side wagers closed button 305. Once this button is pressed, the data (state of each sensor) is recorded (e.g., in the RAM 302, storage device 303, or other medium). Now, chips on the sensors 307 can be removed and the lights will remain on because the data remains the same. Thus, once the side wagers closed button has been pressed, the dealer would typically remove all of the side wagers and place them in the chip rack (e.g., the tubes).

The processor 300 can also be connected to a reset button 306. The reset button is typically pressed after the game has been completed and all side wagers have been resolved (winners paid). The reset button 306 is pressed after the side wagers closed button 305 is pressed and unlocks the locked statuses of the data. In other words, the side wagers closed button 305 locks the data so it will not change and the reset button 306 unlocks the data so it reflects the current state of the sensors (whether or not a side wager (chip) is present on each sensor). For example, once the reset button 305 is pressed, then (assuming no side wagers are present on the sensors) all of the lights 308 would unlight as they would be reflecting the status that no side wager is placed. When each side wager is placed on a sensor 307, the sensor's 307 respective light 308 would then light. Before the side wagers closed button 305 is pressed, if a side wager is removed from a sensor 307 then that respective light 308 would turn off.

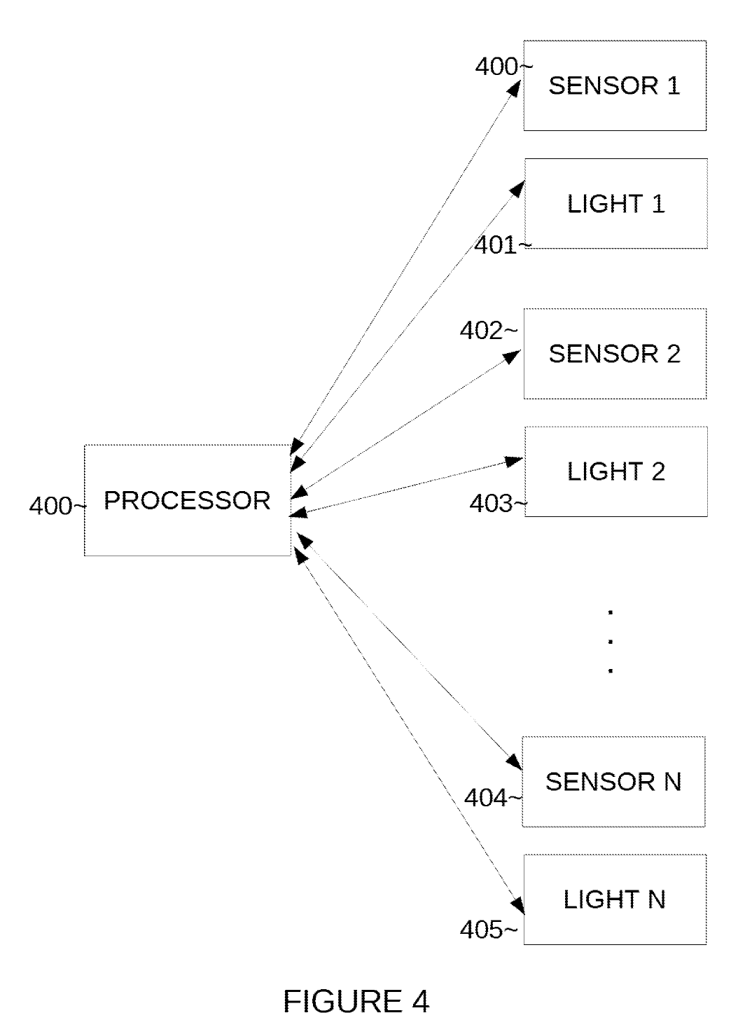

FIG. 4 is a block diagram illustrating the connections between the processor and the lights and sensors, according to an embodiment.

The processor 300 is connected to the sensors 307 and lights 308. Sensors 307 are represented as sensor 1 400, sensor 2 402, sensor N 404. Lights 308 are represented as light 1 401, light 2 403, light N 405. There can be any number of sensors and lights (N can be any number), but of course there should be an equal amount of sensors as lights. Wires would connect each of the sensors and lights to the processor which would typically be hidden and can pass through (or alongside) the chip tray. The wires of course would also provide the power to the sensors and lights and the power source can either be a battery or a connection to an electrical outlet.

The circuit is configured such that each time a sensor is tripped (e.g., a chip is placed on or near it) its respective light will light up (unless the side wagers closed button 505) was last pressed.

Note that there are two states: side wagers open and side wagers closed. When the side wagers closed button 305 is pressed the state is set to side wagers closed. When the reset button 306 is pressed the state is set to side wagers open. The current state can be stored in a memory circuit (e.g., a flip flop or other such memory construct). Thus, when the state is set to side wagers open, then the system is configured such that each light will reflect whether its respective sensor has a chip or not (if it has a chip it will light up, if it does not have a chip it will not light up). Each light can go on and off depending on whether a chip is placed or removed on the respective sensor. When the side wagers closed button 305 is pressed then the status of each sensor can be recorded and transmitted to the data output 309 (going to another system and/or network) which can stored and/or used to compute the current progressive amount. Thus, the progressive contribution is determined based on the point in time when the side wagers closed button 305 is pressed. Also not pictured in FIG. 3 is a network connection wherein the processor 300 can communicate (to/from) with any computer communications network, such as a casino local area network (LAN), the Internet, a WAN, etc.

When the state is set to side wagers closed, the system is configured such that each light will reflect its prior state (e.g., the state at the moment the side wagers closed button is pressed) whether or not a chip is placed or removed in a respective sensor. Thus, when the side wagers closed button 505 the status of each light is “frozen” until the reset button 306 is pressed. Typically, then the dealer would complete a deal of a game, remove all chips from the sensors before the reset button 506 is pressed, which prepares the table for a new game.

FIG. 5 is a drawing of a casino table with a chip tray and sensor bar, according to an embodiment.

A physical casino table 500 has a chip tray 501 embedded into the table 500. The physical casino table 500 can be blackjack table, a baccarat table, or any table used for playing casino games. The chip tray 501 has twelve tubes for holding chips (although it can have any number of tubes). The tubes are actually “half-cylinders.” The chip tray 501 has a sensor bar 502 attached to the chip tray 501. The sensor bar 502 has six circular sensors (although the sensor bar 502 can accommodate any number of sensors), each sensor can detect a chip placed on it and can light up when a chip is placed on it. A drawer 503 is a compartment under the chip tray 501 which can be used to store things, such as the electronics which drive the sensors on the sensor bar 502. In one embodiment, the sensor bar 502 is integrally attached to the chip tray 501.

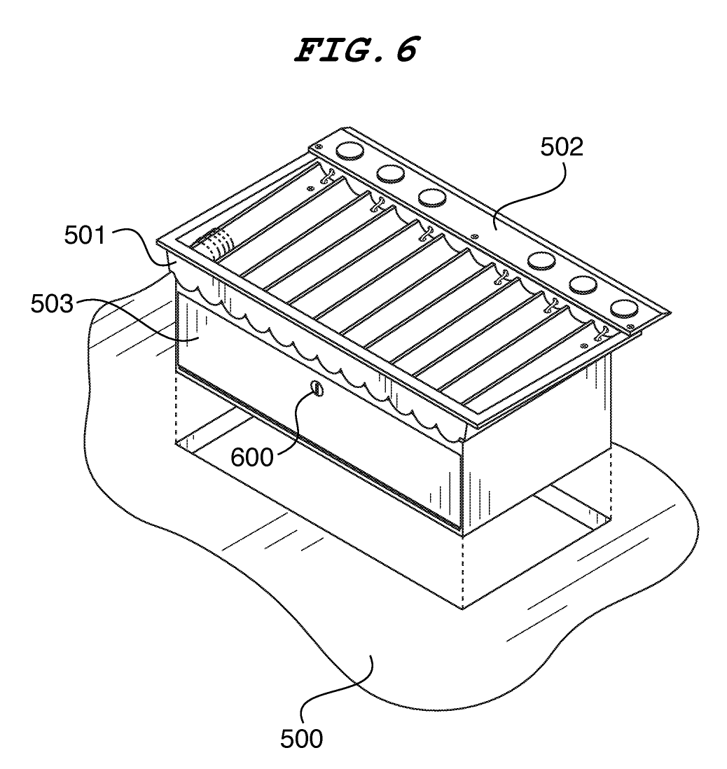

FIG. 6 is a drawing of the chip tray attached to a drawer, according to an embodiment.

The drawer 503 can have an optional lock 600 to open a door on the drawer and access the contents therein. Inside can be the electronics (see FIG. 3) which can drive the sensors and the overall system. Inside the drawer can also be a power supply to drive the processor 300 (and other electronics) and any other device needed to operate the system (e.g., network connection, wifi radio, etc.) The chip tray can optionally be attached to the drawer 503. Hidden wires from each of the sensors would pass through holes in the chip tray and drawer to connect to the electronics inside the drawer 503.

The drawer 503 and chip tray 501 can be lifted out of the table as shown.

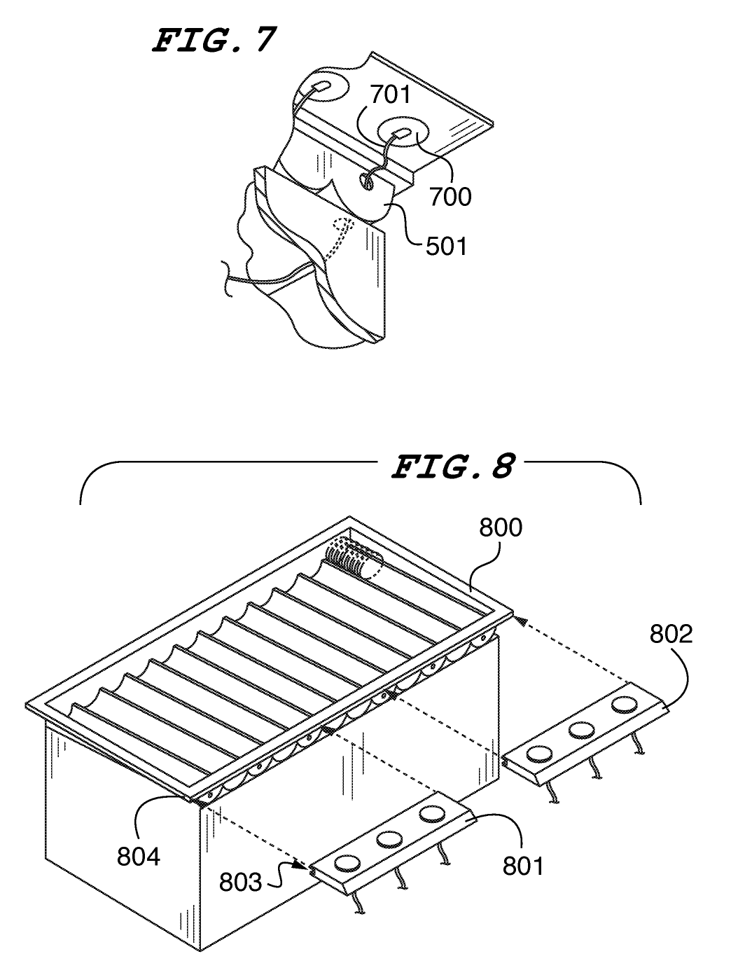

FIG. 7 is a drawing of an underside of the sensor bar, according to an embodiment.

An underside of a sensor 700 is shown with a wire 701 passing through the chip tray 501 which goes to the electronic system inside the drawer 503. Each of the six sensors is identical to the one shown and would have a wire going into the drawer 503. A hole in the chip tray 501 and the drawer 503 can be used to pass each wire from each sensor to the inside of the drawer 503 and connect to the processor 300.

FIG. 8 is a drawing of a pair of sensor bars inserted into a standard chip tray, according to an embodiment.

Instead of a single integrally attached sensor bar 502 as shown in the prior figures, the sensor bar 502 can instead come in the form of two sensor bars 801 802 which can detach from a standard chip tray 800. A first sensor bar 801 has three sensors on it (although of course it can have any number of such sensors) and a second sensor bar 802 also has three sensors on it (although of course it can have any number of such sensors). Both the first sensor bar 801 and the second sensor bar 802 can easily attach and detach from a standard chip tray 800. The first sensor bar 801 and the second sensor bar 802 have a groove 803 which can snap onto a long edge 804 of the standard chip tray 800. There are six holes in the chip tray (one for each of the sensors) so the wire under each sensor can pass through the chip tray 800 and into the drawer to connect to the processor 300. Any other attachment mechanism can be used to attach the two sensor bars 801 802 to the standard chip tray 800 (e.g., tabs, adhesive, magnets, etc.) In a further embodiment, instead of two separate bars 801 802 there would only be one bar comprising all of the sensors (e.g., six or any other number) as described herein that would attach to the standard chip tray (in other words both bars 801 802 would be joined into one longer bar).

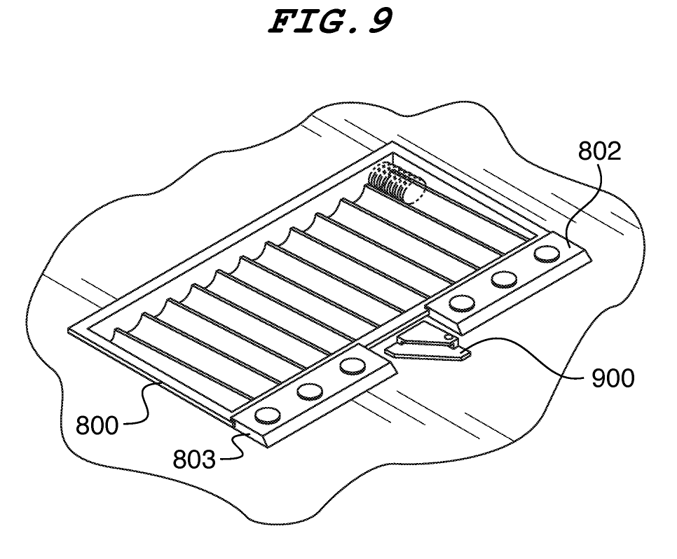

FIG. 9 is a drawing of the pair of sensor bars inserted into the standard chip try with a hole card reader, according to an embodiment.

In the center of the two sensor bars 801 802 can be a “peeker” 900 (also known as a “hole card reader”), this is a device (manual or electronic) which can be used to peek at the hole card (during a blackjack game) and determine whether it is a 10 or an ace without the dealer knowing the value of the card. A hole card is a dealer's card in a blackjack game which is dealt face down. The peeker 900 (or hole card reader) is described in U.S. Pat. No. 5,681,039 which is incorporated by reference herein in its entirety. Hole card peekers can come in mechanical or electronic form (or a hybrid).

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method to receive wagers on a table game, the method comprising:
providing a gaming table comprising a plurality of betting areas, each betting area comprising a main wager betting area and a side wager betting area;
providing a plurality of sensors on or near a chip rack, wherein each one of the plurality of sensors corresponds to each of the plurality of betting areas, wherein each of the plurality of sensors is configured to detect a chip placed therein;
receiving, from a player playing at a first player betting area, a main wager on a respective main wager betting area and a side wager on a respective side wager betting area;
taking, by a dealer, the side wager from the side wager betting area and putting the side wager on a first player sensor out of the plurality of sensors, wherein the putting the side wager on the first player sensor causes the first player sensor to light up;
completing the game by the dealer;
resolving the side wager based on results of the game, wherein the dealer identifies that the first player made the side wager based on the first player sensor, and pays a payout on the side wager to the first player.

2. The method as recited in claim 1, wherein the side wager is a progressive wager.

3. The method as recited in claim 1, wherein each of the plurality of sensors is configured to detect a chip placed therein by weight.

4. The method as recited in claim 1, wherein each of the plurality of sensors is configured to detect a chip placed therein by an absence of light.

5. The method as recited in claim 1, wherein the plurality of sensors are located on the chip rack.

6. The method as recited in claim 1, wherein the plurality of sensors are located not on but near the chip rack.

7. The method as recited in claim 1, wherein the plurality of sensors are located on a bar that attaches to the chip tray.

8. A method to receive wagers on a table game, the method comprising:
providing a gaming table comprising a plurality of betting areas, each of the betting areas located near where each respective player sits, each betting area comprising a main wager betting area and a side wager betting area;
providing a plurality of sensors near or on a chip rack, each of the plurality of sensors corresponds to each of the plurality of betting areas, wherein each of the plurality of sensors is configured to detect and illuminate upon a chip placed therein;
receiving, from a plurality of players playing at the gaming table, a plurality of main wagers and a plurality of side wagers, each of the plurality of main wagers being placed on a respective main wager betting area and each of the plurality of side wagers being placed on a respective side wager betting area;
moving, by a dealer, all of the side wagers from their respective side wager betting circles to their respective sensor out of the plurality of sensors;
dealing and completing the game by the dealer;
resolving the side wager based on results of the game, wherein the dealer identifies which players out of the plurality of players made the side wager based on which of the plurality of sensors are illuminated.

9. The method as recited in claim 8, wherein the side wager is a progressive wager.

10. The method as recited in claim 8, wherein each of the plurality of sensors is configured to detect a chip placed therein by weight.

11. The method as recited in claim 8, wherein each of the plurality of sensors is configured to detect a chip placed therein by an absence of light.

12. The method as recited in claim 8, wherein the plurality of sensors are located on the chip rack.

13. The method as recited in claim 8, wherein the plurality of sensors are located not on but near the chip rack.

14. The method as recited in claim 8, wherein the plurality of sensors are located on a bar that attaches to the chip tray.

15. A chip tray, comprising:
a plurality of adjacent tubes; and
a plurality of sensors on an end of the chip tray, wherein each of the plurality of sensors is configured to detect and illuminate upon a chip placed therein.

16. An apparatus, comprising:
a first bar comprising a plurality of first sensors, wherein of the of the plurality of first sensors is configured to detect and illuminate upon a chip being placed therein;
a second bar comprising a plurality of second sensors, wherein each of the plurality of second sensors is configured to detect and illuminate upon a chip being placed therein; and
wherein the first bar and the second bar are adapted to attach to a chip tray.

17. The apparatus as recited in claim 16, further comprising:
a gaming table comprising the chip tray,
wherein the first bar and the second bar are attached to the chip tray.

18. The apparatus as recited in claim 17, wherein the gaming table further comprising a hole card reader which is located between the first bar and the second bar.
